(19) United States
(12) Patent Application Publication
(10) Pub. No.: US 2008/0281725 A1
(43) Pub. Date: Nov. 13, 2008

(54) Methods and Systems for Selling Shoes at a Hosted Shoe Party

(76) Inventor: Cari Greer, Lindon, UT (US)

Correspondence Address: KIRTON & McCONKIE;A PROFESSIONAL CORPORATION, 1800 EAGLE GATE TOWER, 60 EAST SOUTH TEMPLE STREET, SALT LAKE CITY, UT, 84111, US

(21) Appl. No.: 11/865,879

(22) Filed: Oct. 2, 2007

Related U.S. Application Data
(60) Provisional application No. 60/916,410, filed on May 7, 2007.

(51) Int. Cl. G06F 17/30; G06Q 30/00; G06Q 90/00

(52) U.S. Cl. 705/27; 705/26

(57) ABSTRACT

Embodiments of the present invention relate generally to methods and systems for selling shoes to guests at a hosted shoe party, in which a mobile onsite shoe inventory unit is stocked with an inventory of available shoes in a range of sizes and is transported to the location of the hosted shoe party. A sample of every shoe in the available shoe inventory is displayed to the guests at the hosted shoe party and shoes, in the correct size, are made available to shoe party guests as requested. All orders to purchase shoes may be fulfilled instantly from the stocked mobile onsite shoe inventory unit and payment may be received. The host of the shoe party may receive an incentive for hosting the party and inviting the guests. After each shoe party the mobile onsite shoe inventory unit may be restocked with new inventory for the next shoe party.

### RELATED APPLICATIONS

This application claims priority to U.S. Provisional Patent Application No. 60/916,410 filed May 7, 2007, entitled METHODS AND SYSTEMS FOR SELLING SHOES AT A HOSTED SHOE PARTY.

### FIELD OF THE INVENTION

The present invention relates generally to methods and systems for selling shoes. More particularly, the present invention relates to methods and systems for selling shoes at a hosted shoe party, to a mobile onsite shoe inventory unit that enables orders for shoes received at the hosted shoe party to be filled immediately and to a shoe party website.

### BACKGROUND OF THE INVENTION

Hosted shoe shopping parties have become popular among shoppers who want to avoid traffic, crowded malls and impersonal clerks. A hosted shoe shopping party offers a chance to get together in a fun and exciting shopping atmosphere where you are surrounded by family and friends.

A hosted shoe party may be run by a shoe sales consultant in the home of a host who may invite family, friends and neighbors into their home to see a product line of shoes. Shoe party hosts may be rewarded with free products, credits or other incentives based on the level of sales made at their party. Hosted shoe shopping parties are a new and fun way of marketing shoes by hosting a social event, using the event to display and demonstrate the shoes to those gathered, and then taking orders for the shoes before the gathering ends. While a hosted shoe shopping party offers many advantages over shopping for shoes at a mall or other retail outlet, one of the disadvantages of a home shopping party over shopping at a retail store has been the need to wait for the merchandise to arrive after placing an order at the party.

Accordingly, there is a need in the industry for improved methods and systems for selling shoes.

### SUMMARY OF THE INVENTION

The present invention relates to methods and systems for selling shoes at a hosted shoe party. One embodiment of the present invention relates to a hosted shoe party in which guests are invited to attend a social gathering where a selection of shoes of various styles are displayed and made available for purchase to the guests. The shoe party host may be rewarded with free products or credit toward free products based on the level of sales made at the party. A second embodiment of the present invention relates to a mobile onsite shoe inventory unit that is stocked with an inventory of shoes matching the selections shown to the guests of the party and including all popular sizes of the displayed selections such that orders for shoes received at the hosted shoe party may be filled immediately and payment received at the party. A third embodiment of the present invention relates to a shoe party website through which a prospective host or guest may gain access to schedules of all of the upcoming parties as well as styles of shoes that are available. A visitor to the shoe party website can view current selections and check the calendar to see when and where future parties are going to be held that fit their schedule.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a flow chart of a method for selling shoes at a hosted shoe party in accordance with one embodiment of the present invention;

FIG. 2 is a flow chart of a method for selling shoes at a hosted shoe party comprising a mobile onsite shoe inventory unit in accordance with one embodiment of the present invention;

FIG. 3 is a flow chart of a method for selling shoes at a hosted shoe party comprising a mobile onsite shoe inventory unit and a shoe party website in accordance with one embodiment of the present invention.

### DETAILED DESCRIPTION OF THE PREFERRED EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

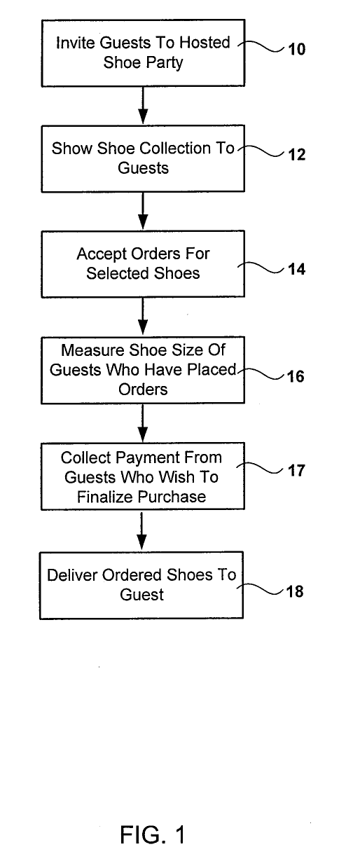

Some embodiments of the present invention, described with reference to FIG. 1, may comprise inviting guests to a hosted shoe party 10. Invitations may be distributed by a shoe party host to friends and family members or others in the host's social circle. Once the guests arrive at the shoe party they may be shown a display of the selection of shoes which are available for purchase 12 at the shoe party. When the guests have had an opportunity to look at all of the available shoes, orders may be accepted 14 from guests interested in purchasing one of the selections. The guests interested in purchasing one of the displayed shoes may give their shoe size if known or may have their shoe size measured 16 by the shoe sales consultant. Once a shoe has been ordered and the correct size obtained, payment may be received 17 for the ordered shoes and the shoes may be delivered 18 to the guest.

Other embodiments of the present invention may comprise a mobile onsite shoe inventory unit. The mobile onsite shoe inventory unit may comprise a truck, van, trailer or some other vehicle capable of carrying an inventory of each shoe available for purchase at the shoe party in a variety of shoe sizes. The mobile onsite shoe inventory unit, with its inventory of shoes in all available sizes, will make it possible for the guests at the shoe party to receive the shoes they purchase instantly and take them home with them. The mobile onsite shoe inventory unit may be organized with shelves, bins and other storage and restraining devices to allow for the most efficient means of storing and transporting an inventory of shoes from one shoe party to the next in a safe and convenient manner. The shelves and bins in the mobile onsite shoe inventory unit may also be organized and labeled with each shoe type, name and size to allow for quick and efficient restocking of the shoe inventory after each shoe party.

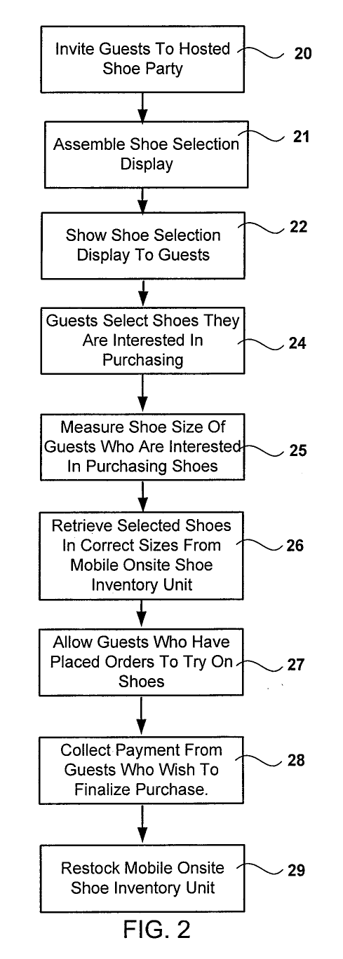

Some embodiments of the present invention, described with reference to FIG. 2, may comprise inviting guests to a hosted shoe party 20. Invitations may be extended to friends and family members of a shoe party host to attend a scheduled shoe party. In some embodiments of the present invention a shoe party sales consultant may arrive early at the home of the shoe party host and assemble a table display, or some other type of display 21, showing all of the shoes available for purchase at the shoe party. After the guests have arrived and the shoe party has begun, guests may be shown the table displaying the entire selection of shoes available for purchase 22. When the guests have had a chance to look at all of the available shoes they may select 24 the shoes they are interested in purchasing. The guests interested in purchasing one of the displayed shoes may give their shoe size, if known, or may have their shoe size measured 25 by the shoe sales consultant. The shoe sales consultant may then retrieve the requested shoe in the correct size from the mobile onsite shoe inventory unit 26 and allow the guest to try the shoes on 27 to ensure that the shoe has the desired look and feel and fits correctly. The shoe sales consultant may then collect payment 28 from the guests who wish to finalize the purchase of their shoes. After the shoe party is over the shoe sales consultant may then restock the mobile onsite shoe inventory unit 29 to replenish the inventory with any shoes styles and sizes that were sold in preparation for the next scheduled shoe party. New shoe styles may also be added.

Further embodiments of the present invention may comprise a shoe party website. The website may provide access to all of the upcoming shoe parties as well as styles of shoes and boots that are available. Website visitors may view current selections and the latest fashion trends and may check a calendar to see when and where the next parties are being held that fit their schedule.

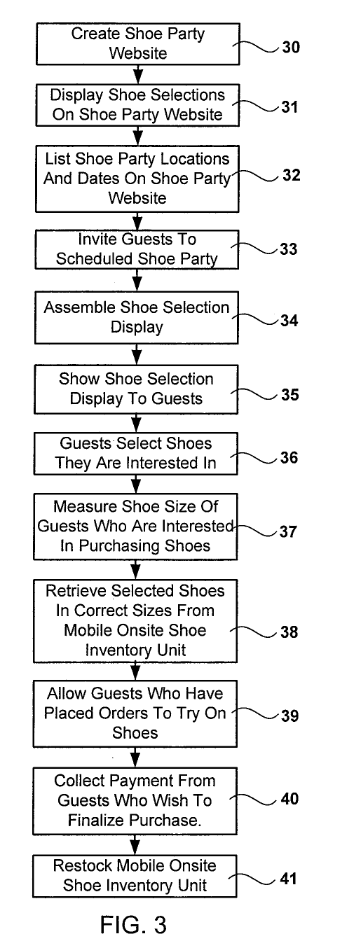

Some embodiments of the present invention, described with reference to FIG. 3, may comprise creating a shoe party website 30 and displaying images of all available shoe styles 31 on the website so that website visitors may be able to see beforehand what shoe styles will be available at the shoe party. The shoe party website may also list 32 the upcoming shoe party dates and locations so that website visitors may see when and where the next parties are being held that fit their schedule. Website visitors may then contact one of the hosts of an upcoming shoe party using the contact information provided on the shoe party website and the host may invite the guest to the shoe party 33. Invitations may also be made by a shoe party host to friends and family members or others in the host's professional and social circles. On the day of the scheduled shoe party, a shoe party sales consultant may arrive early at the home of the shoe party host and assemble a table display, or some other type of display 34, showing all of the shoes available for purchase at the shoe party. After the guests have arrived and the shoe party has begun, guests may be shown the table displaying the entire selection of shoes available for purchase 35. When the guests have had a chance to look at all of the available shoes they may select 36 the shoes they are interested in purchasing. The guests interested in purchasing one of the displayed shoes may give their shoe size if known or may have their shoe size measured 37 by the shoe party sales consultant. The shoe party sales consultant may then retrieve the requested shoe in the correct size from the mobile onsite shoe inventory unit 38 and allow the guest to try on the shoes 39 to ensure that the shoe is comfortable and has the desired look, feel and fit. The shoe party sales consultant may then collect payment 40 from the guests who wish to finalize the purchase of their shoes. After the shoe party is over the shoe party sales consultant may return home and restock the mobile onsite shoe inventory unit 41 with shoe sizes and styles that were depleted at the previous shoe party in preparation for the next shoe party scheduled on the shoe party website. New arrivals may also be added.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

1. A method of conducting business including selling shoes to guests at a hosted shoe party, comprising the steps of:
a) inviting at least one guest to attend a hosted shoe party;
b) displaying a selection of available shoes to the guest at said hosted shoe party;
c) providing a mobile onsite shoe inventory unit at said hosted shoe party comprising a plurality of shoe sizes of each of said displayed selection of available shoes;
d) retrieving from said mobile onsite shoe inventory unit a pair of shoes matching the order in said specific shoe size;
e) receiving payment for said at least one order.

2. The method according to claim 1 further comprising providing incentives to the host of said hosted shoe party according to the amount of merchandise sold at said hosted shoe party.

3. A method of conducting business including selling shoes to guests at a hosted shoe party, comprising the steps of:
a) creating a shoe party website;
b) displaying a plurality of shoe selections on said shoe party website;
c) listing at least one hosted shoe party date and location on said shoe party website;
d) inviting a guest to attend said hosted shoe party;
e) displaying a selection of available shoes to said guest at said at least one hosted shoe party;
f) providing a mobile onsite shoe inventory unit at said hosted shoe party comprising a plurality of shoe sizes of each of said displayed selection of available shoes;
g) retrieving from said mobile onsite shoe inventory unit a pair of shoes matching said at least one order in said specific shoe size;
h) receiving payment for said order.
